(19) United States
(12) Patent Application Publication
(10) Pub. No.: US 2023/0120197 A1
(43) Pub. Date: Apr. 20, 2023

(54) AN AUTOMATION SYSTEM AND A METHOD THAT PROVIDE A GLOBAL VIEW FOR MANAGING ANY INDUSTRIAL CONTROLLER IN A NETWORK

(71) Applicant: Siemens Aktiengesellschaft, Munich (DE)

(72) Inventors: Arquimedes Martinez Canedo, Plainsboro, NJ (US); Lingyun Wang, Princeton, NJ (US)

(21) Appl. No.: 17/905,889

(22) PCT Filed: Mar. 9, 2020
(86) PCT No.: PCT/US2020/021695

§ 371 Date: Sep. 8, 2022

(51) Int. Cl. G05B 11/01; G05B 19/05

(52) U.S. Cl. CPC G05B 11/012; G05B 19/056

(57) ABSTRACT

A system and a method provide a global view of an automation system for any industrial controller in a network. The method comprises providing a distributed version control runtime system for managing industrial controller process images in that an automation engineering process provides non-linear workflows. The method further comprises providing an engineering system having a first industrial controller program database of an industrial controller program. The method further comprises providing a first industrial controller having a first process image including a second industrial controller program database of an industrial controller program and a first historian database. The method further comprises providing a second industrial controller having a second process image including a third industrial controller program database of an industrial controller program and a second historian database. The method further comprises managing versions of the automation code and versions of the data of the industrial controller process image.

### BACKGROUND

### 1. Field

Aspects of the present invention generally relate to a system and a method that provide a global view for managing any industrial controller in a network. A zero downtime distributed process image management system is provided.

### 2. Description of the Related Art

A process image is the heart of a running programmable logic controller (PLC). It provides a snapshot of all inputs, outputs, and internal variables that the PLC has access to at any given point in time, and the PLC source code. The process image is always bound to a specific PLC. The process image may be inspected using an engineering system (e.g., TIA Portal) via a debugging interface to inspect it live.

Today, unfortunately, the process image cannot be explicitly managed. This includes the inability to save it, create copies for testing, clone it to another PLC for inspection or further development, change the values on-the-fly, or push code changes to analyze their effect.

Today, process images are not visible to a user. In PLCs, the process image is a data structure that is visible only to a runtime system and it is used to execute cyclic or event-based PLC programs. When things go wrong in the real world, there are only two ways for people to inspect the problem:

1. Engineering system (e.g., TIA Portal). The engineer must inspect the live process image of each PLC through the engineering system's debugging capabilities. This gives them access to PLC code as it executes live values of inputs, outputs, DBs, and memory. If there are other PLCs involved, the process must be repeated as a separate session. The current limitations only allow the engineer to see a process image that is local to a specific PLC. Moreover, current PLCs do not allow the engineer to save a copy of the process image.

2. Historian. To overcome the limitation #1, the PLCs can save their process image to disk via the historian. This provides engineers more evidence when things go wrong in the real world, however, the historian only provides a recording of the values for only a few minutes. This is true for TIA Portal. The historian feature provided is called S7-Trace. The user can configure a S7-Trace in memory using TIA Portal and depends on the frequency of the data tag, it may only store a few minutes of data before the trace gets overwritten in the memory. The memory in the PLC is very limited. Definitely it is not possible to get a snapshot of the entire process image today. Even if the historian would allow for larger storage and potentially save the process image for years, current PLCs do not allow to load a snapshot of the process image to the PLC for inspection. Other Process Historian solutions come from HMI/SCADA, which is higher layer than PLC in the automation pyramid. The update rate (typically in seconds) is much slower and it is not suitable to store high-speed, high frequency process data.

Therefore, there is a need to better manage a process image of a running programmable logic controller (PLC).

### SUMMARY

Briefly described, aspects of the present invention relate to a system and a method that provide a global view for managing any industrial controller in a network. It manages a process image of a running programmable logic controller (PLC). In particular, a distributed version control runtime system is provided for PLC process images. The runtime system is capable of managing the process image that allows: Versioning of process images—assign tags to process images, Branching of process images—create a fresh copy of a process image, merging of process images—merge changes from one process image version to Another, identifying difference of process images—what's different between process image version 1.0 and version 1.6, attaching process image to device—associate a process image to a PLC, detaching process image from device—disassociate a process image from a PLC, and reverting to any process image version—load a specific process image version. The present invention enables the rapid discovery of bugs and errors in runtime systems, and it provides more flexibility to the automation engineering process by providing non-linear workflows.

In accordance with one illustrative embodiment of the present invention, a computer-implemented method for providing a global view of an automation system for any industrial controller in a network is provided. The method performed by the automation system comprises providing a distributed version control runtime system for managing industrial controller process images where an automation engineering process provides non-linear workflows. An industrial controller process image comprises a data structure of which data is visible to the distributed version control runtime system and an automation code that is used to execute cyclic or event-based industrial controller programs. The method further comprises providing an engineering system having a first industrial controller program database of an industrial controller program. The method further comprises providing a first industrial controller having a first process image including a second industrial controller program database of an industrial controller program and a first historian database of historian data. The method further comprises providing a second industrial controller having a second process image including a third industrial controller program database of an industrial controller program and a second historian database of historian data. The method further comprises managing versions of the automation code and versions of the data of the industrial controller process image via branching from a first version of the industrial controller process image to a second version of the industrial controller process image and merging the first version and the second version of the industrial controller process image.

In accordance with another illustrative embodiment of the present invention, an automation system is provided that provides a global view for managing any industrial controller in a network. The system comprises a processor and an accessible memory storing an automation program comprising software instructions that when executed by the processor are configured to provide a distributed version control runtime system for managing industrial controller process images in that an automation engineering process provides non-linear workflows. An industrial controller process image comprises a data structure in which data is visible to the distributed version control runtime system and an automation code that is used to execute cyclic or event-based industrial controller programs. The software instructions provide an engineering system having a first industrial controller program database of an industrial controller program. The software instructions provide a first industrial controller having a first process image including a second industrial controller program database of an industrial controller program and a first historian database of historian data. The software instructions provide a second industrial controller having a second process image including a third industrial controller program database of an industrial controller program and a second historian database of historian data. The software instructions manage versions of the automation code and versions of the data of the industrial controller process image via branching from a first version of the industrial controller process image to a second version of the industrial controller process image and merging the first version and the second version of the industrial controller process image.

### BRIEF DESCRIPTION OF THE DRAWINGS

FIG. 1 illustrates a block diagram of an automation system that provides a global view for managing any industrial controller in a network in accordance with an exemplary embodiment of the present invention.

FIG. 2 illustrates a block diagram of a distributed version control for PLC process image in accordance with an exemplary embodiment of the present invention.

FIG. 3 illustrates non-linear development, bug fixing, and feature improvement of automation engineering programs with data in accordance with an exemplary embodiment of the present invention.

FIG. 4 illustrates automation component replacement in accordance with an exemplary embodiment of the present invention.

FIG. 5 illustrates a firmware update in accordance with an exemplary embodiment of the present invention.

FIG. 6 illustrates high-availability failover in accordance with an exemplary embodiment of the present invention.

FIG. 7 illustrates a schematic view of a flow chart of a method for providing a global view of an automation system for any industrial controller in a network in accordance with an exemplary embodiment of the present invention.

FIG. 8 shows an example of a computing environment within which embodiments of the disclosure may be implemented.

### DETAILED DESCRIPTION

To facilitate an understanding of embodiments, principles, and features of the present invention, they are explained hereinafter with reference to implementation in illustrative embodiments. In particular, they are described in the context of a system and a method that provide a global view for managing any industrial controller in a network. For example, to manage a process image of a running programmable logic controller (PLC). The present invention takes inspiration from distributed version control systems for source code to allow the process image in PLCs to be versioned and managed. This enables unprecedented new functionality and flexibility to the automation engineering and automation runtime of PLCs. Global view on the automation system is provided. The present invention allows the engineers to see any program version, with any process image version, from any PLC in the network. By providing access to both code and data, the present invention improves the efficiency of the automation engineering process. It allows engineers to quickly identify situations, errors, and problems that would otherwise take longer to identify via indirect methods. The present invention provides the management of process image branches. The present invention provides non-linear development. The present invention provides process image migration. Embodiments of the present invention, however, are not limited to use in the described devices or methods.

The components and materials described hereinafter as making up the various embodiments are intended to be illustrative and not restrictive. Many suitable components and materials that would perform the same or a similar function as the materials described herein are intended to be embraced within the scope of embodiments of the present invention.

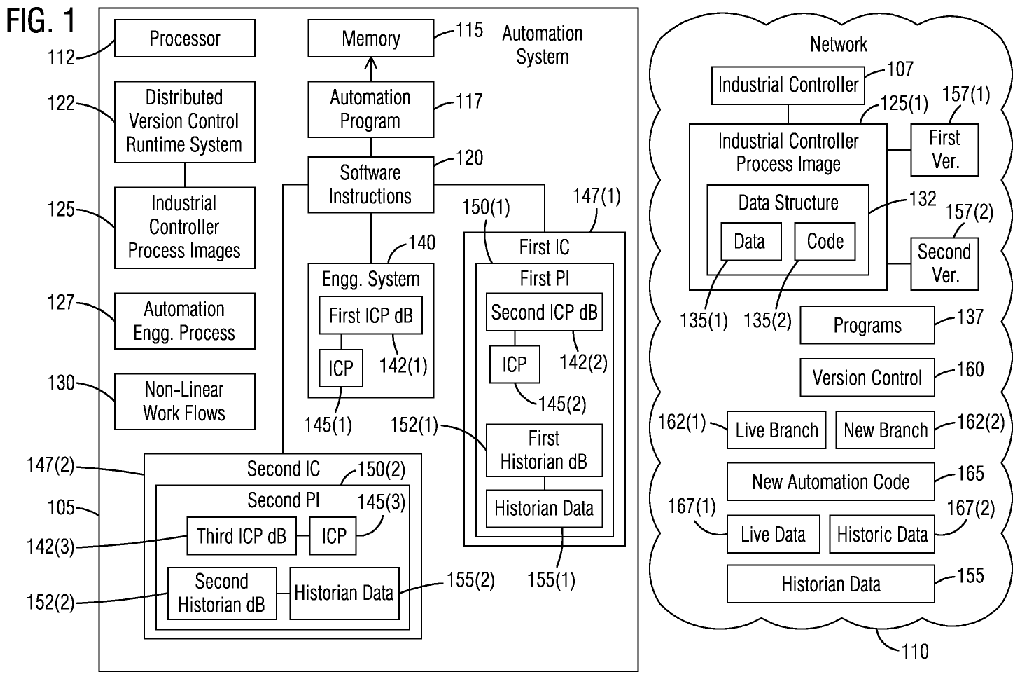

These and other embodiments of an automation system according to the present disclosure are described below with reference to FIGS. 1-8 herein. Like reference numerals used in the drawings identify similar or identical elements throughout the several views. The drawings are not necessarily drawn to scale.

Consistent with one embodiment of the present invention, FIG. 1 represents a block diagram of an automation system 105 that provides a global view for managing any industrial controller 107 in a network 110 in accordance with an exemplary embodiment of the present invention. The automation system 105 comprises a processor 112 and an accessible memory 115 storing an automation program 117 comprising software instructions 120 that when executed by the processor 112 are configured to provide a distributed version control runtime system 122 for managing industrial controller process images 125 in that an automation engineering process 127 provides non-linear workflows 130. An industrial controller process image 125(1) comprises a data structure 132 of which data 135(1) is visible to the distributed version control runtime system 122 and an automation code 135(2) that is used to execute cyclic or event-based industrial controller programs 137.

The software instructions 120 to provide an engineering system 140 having a first industrial controller program database 142(1) of an industrial controller program 145 (1). The software instructions 120 to provide a first industrial controller 147(1) having a first process image 150(1) including a second industrial controller program database 142(2) of an industrial controller program 145(2) and a first historian database 152(1) of historian data 155(1). The software instructions 120 to provide a second industrial controller 147(2) having a second process image 150(2) including a third industrial controller program database 142(3) of an industrial controller program 145(3) and a second historian database 152(2) of historian data 155(2). The software instructions 120 manage versions of the automation code 135(2) and versions of the data 135(1) of the industrial controller process image 125(1) via branching from a first version 157(1) of the industrial controller process image 125(1) to a second version 157(2) of the industrial controller process image 125(1) and merging the first version 157(1) and the second version 157(2) of the industrial controller process image 125(1).

The software instructions 120 when executed by the processor 112 are configured to distribute management of a version control 160 of the industrial controller process image 125(1) across the engineering system 140, the first industrial controller 147(1) and the second industrial controller 147(2). The software instructions 120 when executed by the processor 112 are configured to clone a live branch 162(1) of the industrial controller process image 125(1) into a new branch 162(2) of the industrial controller process image 125(1). The software instructions 120 to modify the industrial controller process image 125(1) by interacting between the live branch 162(1) and the new branch 162(2).

The software instructions 120 test a new automation code 165 of the industrial controller process image 125(1) against a live data 167(1) of a running system. The software instructions 120 test the new automation code 165 of the industrial controller process image 125(1) against a historic data 167(2). The software instructions 120 reproduce any historical situation of the industrial controller process image 125(1) by combining a version of an industrial controller program 145(1) from the engineering system 140, the first industrial controller 147(1) or the second industrial controller 147(2) with a version of historian data 155 from any one or more of the engineering system 140, the first industrial controller 147(1) or the second industrial controller 147(2).

The software instructions 120 store local changes to the automation code 135(2) in the first industrial controller program database 142(1). The software instructions 120 store local changes to inputs, outputs, databases, and memory in the first historian database 152(1).

In one embodiment, the first industrial controller 147(1) is a first programmable logic controller (PLC) and the second industrial controller 147(2) is a second PLC and the industrial controller process image 125(1) is a PLC process image. The software instructions 120 enable migration of the entire PLC process image including both the automation code 135(2) and the data 135(1) from the first PLC to the second PLC with zero downtime. The software instructions 120 patch a firmware of the first PLC with zero downtime. In case of a failure of the first PLC, a slave PLC being the second PLC switches a redundant branch of the second PLC to a live branch of the second PLC from a live branch of the first PLC.

In one embodiment, a global view of an automation system refers to all the data available in the system 105, including sensors, actuators, and controllers. An industrial controller refers to an electronic device that controls an industrial process. A network is a group of interconnected devices. A distributed version control runtime system refers to a runtime system that is an engine that translates a given programming language or languages into machine code. An industrial controller process image comprises a list of inputs, outputs, and internal states of a controller. An automation engineering process refers to a task of writing a control logic in software, and configuration of a control device. A non-linear workflow refers to tasks that occur asynchronously and in a distributed manner. An automation code is a software that runs in a controller that controls a process. Cyclic or event-based industrial controller programs refer to cyclic (repeats itself every X time units) and event-based (repeats itself whenever an event occurs). An engineering system is a software tool to develop automation code and configuration. An industrial controller program database is a database where programs are stored. An industrial controller program is a control code. A historian database of historian data is a database where historian data is stored. A version control refers to a system that records changes in data so it can be recalled later. A live branch is a data set that is being used for controlling a process. Zero downtime means production is not stopped for re-engineering or maintenance.

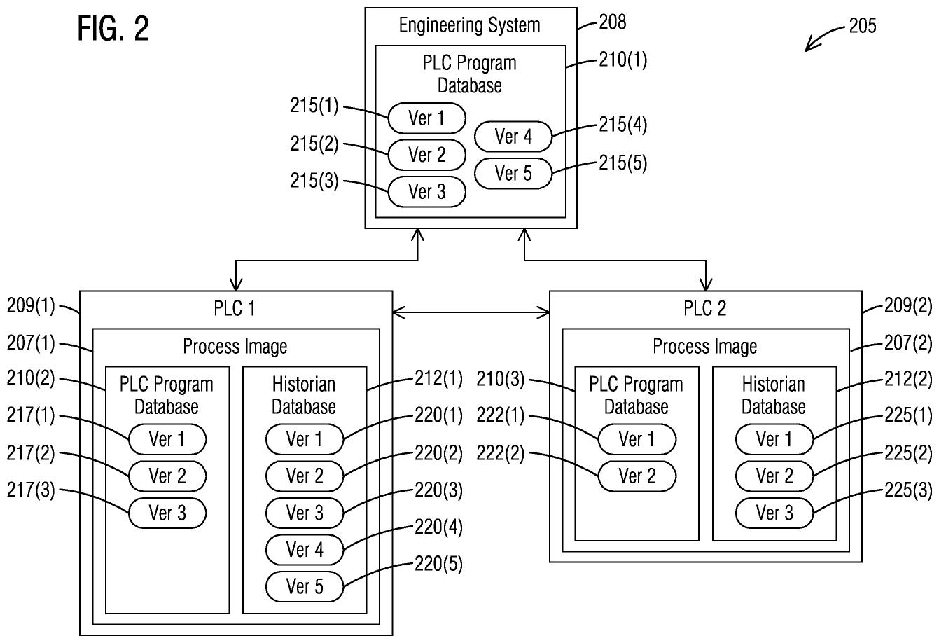

Referring to FIG. 2, it illustrates a block diagram of a distributed version control system 205 for PLC process images 207(1-2) in accordance with an exemplary embodiment of the present invention. The main system architecture of the automation system 105 is as shown in FIG. 2. An engineering system 208 and PLC 1 and PLC 2 209(1-2) has local databases: PLC program DBs 210(1-3) and Historian DBs 212(1-2). The PLC program DB 210(1) has versions VER 1-5 215(1-5). The PLC program DB 210(2) of PLC process image 207(1) has versions VER 1-3 217(1-3). The Historian DB 212(1) of PLC process image 207(1) has versions VER 1-5 220(1-5). The PLC program DB 210(3) of PLC process image 207(2) has versions VER 1-2 222(1-2). The Historian DB 212(2) of PLC process image 207(2) has versions VER 1-3 225(1-3). For example, VER 1 215(1), VER 1 217(1), VER 1 222(1) are the same versions.

The PLC Program Database (DB) 210 stores local changes to the automation code (e.g., IEC 61131-3). The Historian Database (DB) 212 stores local changes to the IOs, DBs, and Memory. This architecture allows the system 105 to reproduce any historical situation by combining a version of a PLC program—from any hardware—with a version of the Historian data—from the same or other hardware. For example, this is very useful after the commissioning phase when there are last-minute changes to the automation code made in the commissioned PLCs. As commissioning engineers find errors or bugs in the software fixes on the spot that today never make it back to the “main” program code. This causes a mismatch between versions. Next time an improvement of the “main” program code is pushed to the field PLCs, the commissioning changes are forever lost. In this architecture, the Historian Database 212 is updated every cycle, and the PLC program Database 210 is updated whenever there are changes to the automation code. The system 105 maintains these two databases separate as the Historian Database 212 is updated at a high-frequency, and the PLC Program Database 210 is updated at a lower frequency. In addition, it involves managing versions of code via branching, merging and cloning.

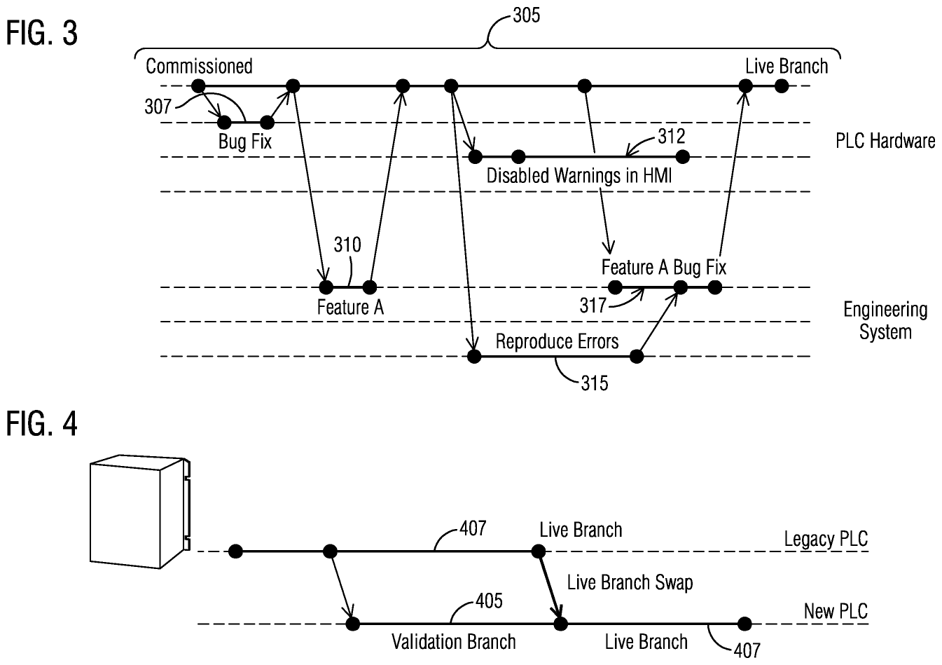

Turning now to FIG. 3, it illustrates non-linear development, bug fixing, and feature improvement of automation engineering programs with data in accordance with an exemplary embodiment of the present invention. The system 105 supports branching and merging. These actions can be visualized through the engineering system as shown in FIG. 3. In a PLC, a live branch 305 is the code version that the PLC is executing. However, the engineers can create branches at any point in time. For example, a bug fix 307 after commissioning done directly in the PLC Hardware is branched, fixed, and merged back to the live branch 305. Similarly, the live branch 305 can be branched from the PLC Hardware into the Engineering System where a new Feature A 310 is developed and merged back to the PLC Hardware. Another type of typical changes are configuration changes to the running system. For example, disabling warnings in the HMI 312 attached to the PLC hardware can be done directly in the PLC Hardware. The live branch 305 of a PLC can also be branched to a remote system such as the Engineering System to reproduce errors 315 when combining a snapshot of the live branch 305 with data from the historian. Likewise, improvements to the Feature A and bug fixes 317 can be done in the Engineering System. After the errors have been fixed, the branch that reproduced errors can be merged locally in the Engineering System with the Feature A bug fixes 317. Then, after some testing, the resulting branch from the Engineering System can be merged to the Live Branch 305 in the PLC Hardware. The live branch 305 has seven dots 320(1-7) each of which represent a version going from left to right version 1 to version 7.

The system 105 allows the migration of the entire process image (both code and data) from one PLC to another with zero downtime. This enables the deployment of high availability applications such as failover, hot patching, and restoration of process images after failures.

FIG. 4 illustrates automation component replacement in accordance with an exemplary embodiment of the present invention. Consider the example in FIG. 4 where a legacy PLC (S7400) is decommissioned and a new PLC (S71500) is commissioned. The system 105 allows: the creation of a validation branch 405 in the new PLC (S71500), after a period of time elapses and the correct behavior of the new PLC is confirmed, a live branch 407 can then be swapped from the legacy system to the new system.

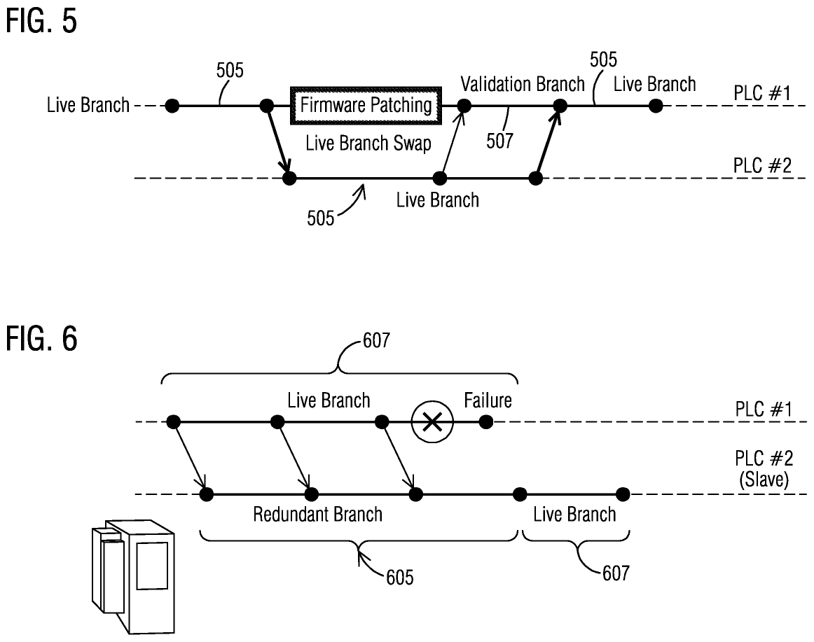

As seen in FIG. 5, it illustrates a firmware update in accordance with an exemplary embodiment of the present invention. Consider the example in FIG. 5 where the firmware of a PLC is patched with zero downtime. First, a live branch 505 is swapped to another PLC. Then the PLC is patched. After the successful patch is confirmed, then a validation branch 507 is created and executed until correct behavior is confirmed. Then, the live branch 505 can be swapped back to the now patched PLC.

As shown in FIG. 6, it illustrates high-availability failover in accordance with an exemplary embodiment of the present invention. Consider the example in FIG. 6 where two PLCs are configured redundantly. A redundant branch 605 in a slave PLC is created and synchronized on every cycle. In case of a failure, a live branch 607 does not synchronize, and the slave PLC switches the redundant branch 605 to the live branch 607.

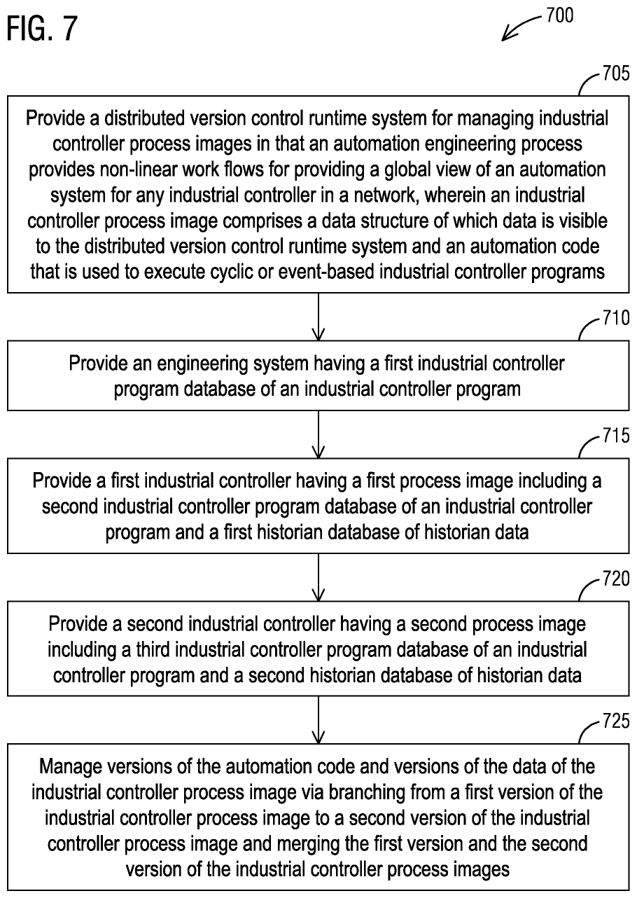

In FIG. 7, it illustrates a schematic view of a flow chart of a method 700 for providing a global view of an automation system for any industrial controller in a network in accordance with an exemplary embodiment of the present invention. Reference is made to the elements and features described in FIGS. 1-6. It should be appreciated that some steps are not required to be performed in any particular order, and that some steps are optional.

The method 700 comprises a step 705 of providing a distributed version control runtime system for managing industrial controller process images in that an automation engineering process provides non-linear workflows. An industrial controller process image comprises a data structure of which data is visible to the distributed version control runtime system and an automation code that is used to execute cyclic or event-based industrial controller programs. The method 700 further comprises a step 710 of providing an engineering system having a first industrial controller program database of an industrial controller program.

The method 700 further comprises a step 715 of providing a first industrial controller having a first process image including a second industrial controller program database of an industrial controller program and a first historian database of historian data. The method 700 further comprises a step 720 of providing a second industrial controller having a second process image including a third industrial controller program database of an industrial controller program and a second historian database of historian data. The method 700 further comprises a step 725 of managing versions of the automation code and versions of the data of the industrial controller process image via branching from a first version of the industrial controller process image to a second version of the industrial controller process image and merging the first version and the second version of the industrial controller process image.

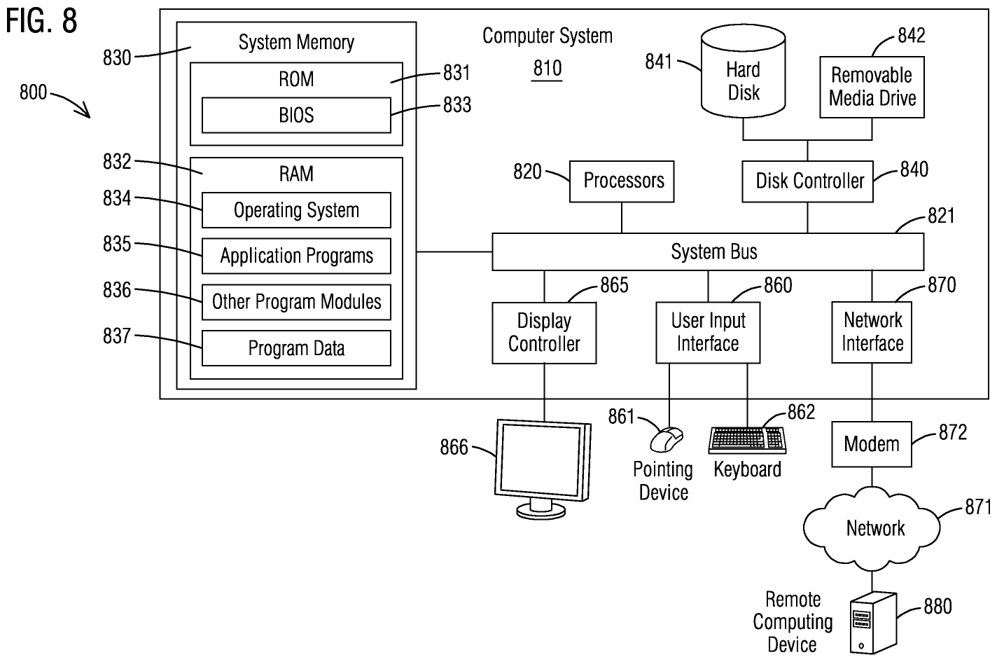

With regard to FIG. 8, it shows an example of a computing environment 800 within which embodiments of the disclosure may be implemented. For example, this computing environment 800 may be configured to execute the automation system discussed above with reference to FIG. 1 or to execute portions of the method 700 described above with respect to FIG. 7. Computers and computing environments, such as computer system 810 and computing environment 800, are known to those of skill in the art and thus are described briefly here.

As shown in FIG. 8, the computer system 810 may include a communication mechanism such as a bus 821 or other communication mechanism for communicating information within the computer system 810. The computer system 810 further includes one or more processors 820 coupled with the bus 821 for processing the information. The processors 820 may include one or more central processing units (CPUs), graphical processing units (GPUs), or any other processor known in the art.

The computer system 810 also includes a system memory 830 coupled to the bus 821 for storing information and instructions to be executed by processors 820. The system memory 830 may include computer readable storage media in the form of volatile and/or nonvolatile memory, such as read only memory (ROM) 831 and/or random access memory (RAM) 832. The system memory RAM 832 may include other dynamic storage device(s) (e.g., dynamic RAM, static RAM, and synchronous DRAM). The system memory ROM 831 may include other static storage device(s) (e.g., programmable ROM, erasable PROM, and electrically erasable PROM). In addition, the system memory 830 may be used for storing temporary variables or other intermediate information during the execution of instructions by the processors 820. A basic input/output system (BIOS) 833 containing the basic routines that helps to transfer information between elements within computer system 810, such as during start-up, may be stored in ROM 831. RAM 832 may contain data and/or program modules that are immediately accessible to and/or presently being operated on by the processors 820. System memory 830 may additionally include, for example, operating system 1034, application programs 835, other program modules 836 and program data 837.

The computer system 810 also includes a disk controller 840 coupled to the bus 821 to control one or more storage devices for storing information and instructions, such as a hard disk 841 and a removable media drive 842 (e.g., floppy disk drive, compact disc drive, tape drive, and/or solid state drive). The storage devices may be added to the computer system 810 using an appropriate device interface (e.g., a small computer system interface (SCSI), integrated device electronics (IDE), Universal Serial Bus (USB), or FireWire).

The computer system 810 may also include a display controller 865 coupled to the bus 821 to control a display 866, such as a cathode ray tube (CRT) or liquid crystal display (LCD), for displaying information to a computer user. The computer system includes an input interface 860 and one or more input devices, such as a keyboard 862 and a pointing device 861, for interacting with a computer user and providing information to the processor 820. The pointing device 861, for example, may be a mouse, a trackball, or a pointing stick for communicating direction information and command selections to the processor 820 and for controlling cursor movement on the display 866. The display 866 may provide a touch screen interface which allows input to supplement or replace the communication of direction information and command selections by the pointing device 1061.

The computer system 810 may perform a portion or all of the processing steps of embodiments of the invention in response to the processors 820 executing one or more sequences of one or more instructions contained in a memory, such as the system memory 830. Such instructions may be read into the system memory 830 from another computer readable medium, such as a hard disk 841 or a removable media drive 842. The hard disk 841 may contain one or more datastores and data files used by embodiments of the present invention. Datastore contents and data files may be encrypted to improve security. The processors 820 may also be employed in a multi-processing arrangement to execute the one or more sequences of instructions contained in system memory 830. In alternative embodiments, hard-wired circuitry may be used in place of or in combination with software instructions. Thus, embodiments are not limited to any specific combination of hardware circuitry and software.

As stated above, the computer system 810 may include at least one computer readable medium or memory for holding instructions programmed according to embodiments of the invention and for containing data structures, tables, records, or other data described herein. The term “computer readable medium” as used herein refers to any medium that participates in providing instructions to the processor 820 for execution. A computer readable medium may take many forms including, but not limited to, nonvolatile media, volatile media, and transmission media. Non-limiting examples of nonvolatile media include optical disks, solid state drives, magnetic disks, and magneto-optical disks, such as hard disk 841 or removable media drive 842. Non-limiting examples of volatile media include dynamic memory, such as system memory 830. Non-limiting examples of transmission media include coaxial cables, copper wire, and fiber optics, including the wires that make up the bus 821. Transmission media may also take the form of acoustic or light waves, such as those generated during radio wave and infrared data communications.

The computing environment 800 may further include the computer system 810 operating in a networked environment using logical connections to one or more remote computers, such as remote computer 880. Remote computer 880 may be a personal computer (laptop or desktop), a mobile device, a server, a router, a network PC, a peer device or other common network node, and typically includes many or all of the elements described above relative to computer system 810. When used in a networking environment, computer system 810 may include modem 872 for establishing communications over a network 871, such as the Internet. Modem 872 may be connected to bus 821 via user network interface 870, or via another appropriate mechanism.

Network 871 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 810 and other computers (e.g., remote computer 880). The network 871 may be wired, wireless or a combination thereof. Wired connections may be implemented using Ethernet, Universal Serial Bus (USB), RJ-11 or any other wired connection generally known in the art. Wireless connections may be implemented using Wi-Fi, WiMAX, and Bluetooth, infrared, cellular networks, satellite or any other wireless connection methodology generally known in the art. Additionally, several networks may work alone or in communication with each other to facilitate communication in the network 871.

In some embodiments, the computer system 810 may be utilized in conjunction with a parallel processing platform comprising a plurality of processing units. This platform may allow parallel execution of one or more of the tasks associated with optimal design generation, as described above. For the example, in some embodiments, execution of multiple product lifecycle simulations may be performed in parallel, thereby allowing reduced overall processing times for optimal design selection.

The embodiments of the present disclosure may be implemented with any combination of hardware and software. In addition, the embodiments of the present disclosure may be included in an article of manufacture (e.g., one or more computer program products) having, for example, computer-readable, non-transitory media. The media has embodied therein, for instance, computer readable program code for providing and facilitating the mechanisms of the embodiments of the present disclosure. The article of manufacture can be included as part of a computer system or sold separately.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters.

A graphical user interface (GUI), as used herein, comprises one or more display images, generated by a display processor and enabling user interaction with a processor or other device and associated data acquisition and processing functions. The GUI also includes an executable procedure or executable application. The executable procedure or executable application conditions the display processor to generate signals representing the GUI display images. These signals are supplied to a display device which displays the image for viewing by the user. The processor, under control of an executable procedure or executable application, manipulates the GUI display images in response to signals received from the input devices. In this way, the user may interact with the display image using the input devices, enabling user interaction with the processor or other device.

The functions and process steps herein may be performed automatically or wholly or partially in response to user command. An activity (including a step) performed automatically is performed in response to one or more executable instructions or device operation without user direct initiation of the activity.

The system and processes of the figures are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. As described herein, the various systems, subsystems, agents, managers and processes can be implemented using hardware components, software components, and/or combinations thereof.

Computer readable medium instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, may be implemented by computer readable medium instructions.

It should be appreciated that the program modules, applications, computer-executable instructions, code, or the like depicted in FIG. 8 as being stored in the system memory are merely illustrative and not exhaustive and that processing described as being supported by any particular module may alternatively be distributed across multiple modules or performed by a different module. In addition, various program module(s), script(s), plug-in(s), Application Programming Interface(s) (API(s)), or any other suitable computer-executable code hosted locally on the computer system 810, the remote device, and/or hosted on other computing device(s) accessible via one or more of the network(s), may be provided to support functionality provided by the program modules, applications, or computer-executable code depicted in FIG. 8 and/or additional or alternate functionality. Further, functionality may be modularized differently such that processing described as being supported collectively by the collection of program modules depicted in FIG. 8 may be performed by a fewer or greater number of modules, or functionality described as being supported by any particular module may be supported, at least in part, by another module. In addition, program modules that support the functionality described herein may form part of one or more applications executable across any number of systems or devices in accordance with any suitable computing model such as, for example, a client-server model, a peer-to-peer model, and so forth. In addition, any of the functionality described as being supported by any of the program modules depicted in FIG. 8 may be implemented, at least partially, in hardware and/or firmware across any number of devices.

It should further be appreciated that the computer system 810 may include alternate and/or additional hardware, software, or firmware components beyond those described or depicted without departing from the scope of the disclosure. More particularly, it should be appreciated that software, firmware, or hardware components depicted as forming part of the computer system 810 are merely illustrative and that some components may not be present or additional components may be provided in various embodiments. While various illustrative program modules have been depicted and described as software modules stored in system memory, it should be appreciated that functionality described as being supported by the program modules may be enabled by any combination of hardware, software, and/or firmware. It should further be appreciated that each of the above-mentioned modules may, in various embodiments, represent a logical partitioning of supported functionality. This logical partitioning is depicted for ease of explanation of the functionality and may not be representative of the structure of software, hardware, and/or firmware for implementing the functionality. Accordingly, it should be appreciated that functionality described as being provided by a particular module may, in various embodiments, be provided at least in part by one or more other modules. Further, one or more depicted modules may not be present in certain embodiments, while in other embodiments, additional modules not depicted may be present and may support at least a portion of the described functionality and/or additional functionality. Moreover, while certain modules may be depicted and described as sub-modules of another module, in certain embodiments, such modules may be provided as independent modules or as sub-modules of other modules.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure. In addition, it should be appreciated that any operation, element, component, data, or the like described herein as being based on another operation, element, component, data, or the like can be additionally based on one or more other operations, elements, components, data, or the like. Accordingly, the phrase “based on,” or variants thereof, should be interpreted as “based at least in part on.”

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While a programmable logic controller (PLC) is described here a range of one or more other industrial controllers or other forms of industrial controllers are also contemplated by the present invention. For example, other types of industrial controllers may be implemented based on one or more features presented above without deviating from the spirit of the present invention.

The techniques described herein can be particularly useful for industrial controller process image. While particular embodiments are described in terms of the industrial controller process image, the techniques described herein are not limited to industrial controller process image but can also be used with other data structures.

While embodiments of the present invention have been disclosed in exemplary forms, it will be apparent to those skilled in the art that many modifications, additions, and deletions can be made therein without departing from the spirit and scope of the invention and its equivalents, as set forth in the following claims.

Embodiments and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure embodiments in detail. It should be understood, however, that the detailed description and the specific examples, while indicating preferred embodiments, are given by way of illustration only and not by way of limitation. Various substitutions, modifications, additions and/or rearrangements within the spirit and/or scope of the underlying inventive concept will become apparent to those skilled in the art from this disclosure.

As used herein, the terms “comprises,” “comprising,” “includes,” “including,” “has,” “having” or any other variation thereof, are intended to cover a non-exclusive inclusion. For example, a process, article, or apparatus that comprises a list of elements is not necessarily limited to only those elements but may include other elements not expressly listed or inherent to such process, article, or apparatus.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms.

In the foregoing specification, the invention has been described with reference to specific embodiments. However, one of ordinary skill in the art appreciates that various modifications and changes can be made without departing from the scope of the invention. Accordingly, the specification and figures are to be regarded in an illustrative rather than a restrictive sense, and all such modifications are intended to be included within the scope of invention.

Although the invention has been described with respect to specific embodiments thereof, these embodiments are merely illustrative, and not restrictive of the invention. The description herein of illustrated embodiments of the invention is not intended to be exhaustive or to limit the invention to the precise forms disclosed herein (and in particular, the inclusion of any particular embodiment, feature or function is not intended to limit the scope of the invention to such embodiment, feature or function). Rather, the description is intended to describe illustrative embodiments, features and functions in order to provide a person of ordinary skill in the art context to understand the invention without limiting the invention to any particularly described embodiment, feature or function. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Respective appearances of the phrases “in one embodiment,” “in an embodiment,” or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

It will also be appreciated that one or more of the elements depicted in the drawings/figures can also be implemented in a more separated or integrated manner, or even removed or rendered as inoperable in certain cases, as is useful in accordance with a particular application.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component.

What is claimed is:

1. A computer-implemented method of providing a global view of an automation system for any industrial controller in a network, the method performed by the automation system and comprising:
through operating at least one processor:
providing a distributed version control runtime system for managing industrial controller process images where an automation engineering process provides non-linear workflows, wherein an industrial controller process image comprises a data structure where data is visible to the distributed version control runtime system and an automation code that executes cyclic or event-based industrial controller programs;
providing an engineering system having a first industrial controller program database of an industrial controller program;
providing a first industrial controller having a first process image including a second industrial controller program database of an industrial controller program and a first historian database of historian data;
providing a second industrial controller having a second process image including a third industrial controller program database of an industrial controller program and a second historian database of historian data; and
managing versions of the automation code and versions of the data of the industrial controller process image via branching from a first version of the industrial controller process image to a second version of the industrial controller process image and merging the first version and the second version of the industrial controller process image.

2. The method of claim 1, further comprising:
distributing management of a version control of the industrial controller process image across the engineering system, the first industrial controller and the second industrial controller.

3. The method of claim 1, further comprising:
cloning a live branch of the industrial controller process image into a new branch of the industrial controller process image;
modifying the industrial controller process image by interacting between the live branch and the new branch.

4. The method of claim 1, further comprising:
testing a new automation code of the industrial controller process image against a live data of a running system.

5. The method of claim 1, further comprising:
testing a new automation code of the industrial controller process image against a historic data.

6. The method of claim 1, further comprising:
reproducing any historical situation of the industrial controller process image by combining a version of an industrial controller program from the engineering system, the first industrial controller or the second industrial controller with a version of historian data from any one or more of the engineering system, the first industrial controller or the second industrial controller.

7. The method of claim 1, further comprising:
storing local changes to the automation code in the first industrial controller program database; and
storing local changes to inputs, outputs, databases, and memory in the first historian database.

8. The method of claim 1, further comprising:
managing versions of code via branching, merging and cloning.

9. The method of claim 1, wherein the first industrial controller is a first programmable logic controller (PLC) and the second industrial controller is a second PLC and the industrial controller process image is a PLC process image.

10. The method of claim 9, further comprising:
enabling migration of the entire PLC process image including both the automation code and the data from the first PLC to the second PLC with zero downtime.

11. The method of claim 9, further comprising:
patching a firmware of the first PLC with zero downtime.

12. The method of claim 9, further comprising:
in case of a failure of the first PLC, a slave PLC being the second PLC switches a redundant branch of the second PLC to a live branch of the second PLC from a live branch of the first PLC.

13. An automation system that provides a global view for managing any industrial controller in a network, the system comprising:
a processor; and
an accessible memory storing an automation program comprising software instructions that when executed by the processor are configured to:
provide a distributed version control runtime system for managing industrial controller process images in an automation engineering process providing non-linear workflows, wherein an industrial controller process image comprises a data structure where data is visible to the distributed version control runtime system and an automation code that is used to execute cyclic or event-based industrial controller programs;
provide an engineering system having a first industrial controller program database of an industrial controller program;
provide a first industrial controller having a first process image including a second industrial controller program database of an industrial controller program and a first historian database of historian data;
provide a second industrial controller having a second process image including a third industrial controller program database of an industrial controller program and a second historian database of historian data; and
manage versions of the automation code and versions of the data of the industrial controller process image via branching from a first version of the industrial controller process image to a second version of the industrial controller process image and merging the first version and the second version of the industrial controller process image.

14. The automation system of claim 13, wherein software instructions when executed by the processor are configured to:
distribute management of a version control of the industrial controller process image across the engineering system, the first industrial controller and the second industrial controller.

15. The automation system of claim 13, wherein software instructions when executed by the processor are configured to:
clone a live branch of the industrial controller process image into a new branch of the industrial controller process image;
modify the industrial controller process image by interacting between the live branch and the new branch.

16. The automation system of claim 13, wherein software instructions when executed by the processor are configured to:
test a new automation code of the industrial controller process image against a live data of a running system.

17. The automation system of claim 13, wherein software instructions when executed by the processor are configured to:
test a new automation code of the industrial controller process image against a historic data.

18. The automation system of claim 13, wherein software instructions when executed by the processor are configured to:
reproduce any historical situation of the industrial controller process image by combining a version of an industrial controller program from the engineering system, the first industrial controller or the second industrial controller with a version of historian data from any one or more of the engineering system, the first industrial controller or the second industrial controller.

19. A non-transitory computer-readable storage medium encoded with instructions executable by at least one processor to operate one or more automation systems, the instructions comprising:
provide a distributed version control runtime system for managing industrial controller process images where an automation engineering process provides non-linear workflows, wherein an industrial controller process image comprises a data structure where data is visible to the distributed version control runtime system and an automation code that is used to execute cyclic or event-based industrial controller programs;
provide an engineering system having a first industrial controller program database of an industrial controller program;
provide a first industrial controller having a first process image including a second industrial controller program database of an industrial controller program and a first historian database of historian data;
provide a second industrial controller having a second process image including a third industrial controller program database of an industrial controller program and a second historian database of historian data; and
manage versions of the automation code and versions of the data of the industrial controller process image via branching from a first version of the industrial controller process image to a second version of the industrial controller process image and merging the first version and the second version of the industrial controller process image.

20. The computer-readable medium of claim 19, wherein an automation program is configured to distribute management of a version control of the industrial controller process image across the engineering system, the first industrial controller and the second industrial controller.
